(19) United States
(12) Patent Application Publication
(10) Pub. No.: US 2025/0209691 A1
(43) Pub. Date: Jun. 26, 2025

(54) IMAGE GENERATION METHOD, APPARATUS, ELECTRONIC DEVICE, AND STORAGE MEDIUM

(71) Applicant: Beijing Zitiao Network Technology Co., Ltd., Haidian District (CN)

(72) Inventor: Zhenghao Guan, Beijing (CN)

(21) Appl. No.: 18/980,576

(22) Filed: Dec. 13, 2024

(30) Foreign Application Priority Data
Dec. 25, 2023 (CN) 202311801500.0

(51) Int. Cl. G06T 11/20; G06T 11/40

(52) U.S. Cl. CPC G06T 11/203; G06T 11/40

(57) ABSTRACT

Embodiments of the present disclosure provide an image generation method, an apparatus, an electronic device, and a storage medium. The method comprises: determining a reference trunk direction of an effect object according to a predetermined initial point and a target offset in response to an image generation condition being satisfied; determining at least one piece of extension information according to the initial point, the reference trunk direction and a predetermined target parameter; generating an effect image of the effect object based on the at least one piece of extension information.

### CROSS-REFERENCE TO RELATED APPLICATION(S)

This application claims priority to Chinese Application No. 202311801500.0 filed in Dec. 25, 2023, the disclosures of which are incorporated herein by reference in their entireties.

### FIELD

Embodiments of the present disclosure generally relate to the field of effect processing, and more specifically, to an image generation method, an apparatus, an electronic device, and a storage medium.

### SUMMARY

The present disclosure provides an image generation method, an apparatus, an electronic device, and a storage medium to realize the effect of randomly generating an effect image of an effect object, and further improve the effect of the effect image on the basis of ensuring the generation efficiency of the effect image.

In a first aspect of the present disclosure, there is provided an image generation method. The method comprises:
determining a reference trunk direction or a reference main part direction of an effect object according to a predetermined initial point and a target offset in response to an image generation condition being satisfied;
determining at least one piece of extension information according to the initial point, the reference trunk direction and a predetermined target parameter;
generating an effect image of the effect object based on the at least one piece of extension information.

In a second aspect of the present disclosure, there is provided an image generation apparatus. The apparatus comprises:
a reference trunk direction determination module for determining a reference trunk direction of an effect object according to a predetermined initial point and a target offset in response to an image generation condition being satisfied;
an extension information determination module for determining at least one piece of extension information according to the initial point, the reference trunk direction and a predetermined target parameter, wherein the extension information comprises an extension position and a corresponding target extension direction;
an effect image generation module for generating an effect image of the effect object based on the at least one piece of extension information.

In a third aspect of the present disclosure, there is provided an electronic device. The electronic device comprises:
one or more processors;
a storage apparatus for storing one or more programs;
the one or more programs, when executed by the one or more processors, cause the one or more processors to implement the image generation method of the embodiments of the present disclosure.

In a fourth aspect of the present disclosure, there is provided a storage medium containing computer-executable instructions for executing the image generation method of the embodiments of the present disclosure.

### BRIEF DESCRIPTION OF THE DRAWINGS

Through the following detailed specific embodiments with reference to the drawings, the above and other objectives, features, and advantages of example embodiments of the present disclosure will become more apparent. Throughout the drawings, the same reference numerals usually refer to the same components. It should be understood that the drawings are diagrammatic and that elements and elements are not necessarily drawn to scale.

FIG. 1 illustrates a schematic flow diagram of an image generation method in accordance with an embodiment of the present disclosure;

FIG. 2 illustrates an effect diagram of an effect image in accordance with an embodiment of the present disclosure;

FIG. 3 illustrates a schematic flow diagram of another image generation method in accordance with an embodiment of the present disclosure;

FIG. 4 illustrates a schematic diagram of a trunk extension information determination process in accordance with an embodiment of the present disclosure;

FIG. 5 illustrates a schematic diagram of a trunk extension information and branch extension information determination process in accordance with an embodiment of the present disclosure;

FIG. 6 illustrates a flow diagram of another image generation method in accordance with an embodiment of the present disclosure;

FIG. 7 illustrates a schematic configuration diagram of an image generation apparatus in accordance with an embodiment of the present disclosure;

FIG. 8 illustrates a block diagram of an electronic device in accordance with an embodiment of the present disclosure.

### DETAILED DESCRIPTION OF EMBODIMENTS

Embodiments of the present disclosure will be described in more details below with reference to the drawings. Although the drawings illustrate preferred embodiments of the present disclosure, it should be appreciated that the present disclosure can be implemented in various manners and should not be limited to the embodiments explained herein. On the contrary, the embodiments are provided to make the present disclosure more thorough and complete. It should be understood that the drawings and embodiments of the present disclosure are for illustrative purposes only and are not intended to limit the scope of the present disclosure.

It should be understood that the various steps recited in the method embodiments of the present disclosure may be executed in a different order and/or in parallel. Moreover, method embodiments may include additional steps and/or omit executing the steps shown. The scope of the present disclosure is not limited in this respect.

As used herein, the term “includes” and its variants are to be read as open-ended terms that mean “includes, but is not limited to”. The term “based on” is to be read as “based at least in part on”. The terms “one example embodiment” is to be read as “at least one example embodiment”. The term “a further embodiment” is to be read as “at least a further embodiment”. The term “some embodiments” is to be read as “at least some embodiments”. Relevant definitions of other terms will be given in the following description.

It should be noted that references to “first”, “second”, and the like in the present disclosure are only used to distinguish different devices, modules, or units and are not intended to limit the order or interdependence of the functions executed by the devices, modules, or units.

It is noted that the modifications referred to “a” and “an” throughout the present disclosure are intended to be illustrative and not restrictive, and those skilled in the art would understand that “one or more” is to be read unless the context clearly indicates otherwise.

The names of messages or information interacted between devices in embodiments of the present disclosure are for illustrative purposes only and are not intended to limit the scope of such messages or information.

It should be understood that prior to using the technical solutions disclosed in the various embodiments of the present disclosure, the type, scope of use, use scenario, etc. of personal information involved in the present disclosure should be informed to and authorized by the user in an appropriate manner according to relevant laws and regulations.

With the development of network technology, increasingly more applications come into user's life, and especially, a series of software which are capable of shooting short videos are favored by users.

In the prior art, a software developer may add various effect objects in an application for users in shooting a video. However, the effect objects provided for the user are limited at present, and the quality of the video and the richness of the content thereof need to be further improved. Meanwhile, when an effect object is an object with a certain growth rule, a pattern style of an effect image of the effect object is usually set in advance, and the pattern style of the generated effect image of the effect object may have certain limitations of single display effects, resulting poor user experience with the application software.

For example, in response to an active request from a user, prompt information is sent to the user to explicitly prompt the user that the operation requested to be executed will require obtaining and using personal information of the user. Accordingly, the user can autonomously select whether to provide personal information to software or hardware, such as an electronic device, an application program, a server or a storage medium which execute the operation of the technical solution of the present disclosure, according to prompt information.

As an alternative but non-limiting implementation, in response to an active request from a user, the prompt message may be sent to the user, for example, in the manner of a pop-up window in which the prompt message may be presented in text. In addition, the pop-up window may also carry a selection control for the user to select “agree” or “disagree” to provide personal information to the electronic device.

It is to be understood that the above-described notification and obtaining user authorization processes are merely illustrative and do not limit the implementation of the present disclosure, and that other ways of satisfying relevant laws and regulations may also be applied to implementations of the present disclosure.

It is understood that the data involved in the present technical solution (including but not limited to the data itself and the acquisition or use of the data) shall comply with the requirements of relevant laws and regulations and relevant provisions.

Before introducing the present solution, an application scenario may be exemplified. The technical solution can be applied to any scene in which effect images of effect objects need to be generated. Illustratively, upon the detection that an image generation condition is satisfied, an effect image of an effect object may be generated, and the generated effect image may be added to a video picture displayed in a terminal device display interface. In the related art, an effect image of an effect object is generally pre-generated, and in response to an image generation condition being satisfied, the pre-generated effect image is called and added to a video picture. In such way, there may be some limitations in the pattern of the effect image of the generated effect object that the display effect of the effect image is relatively single.

In this regard, based on a technical solution of an embodiment of the present disclosure, at least one piece of extension information of an effect object can be determined according to an initial point, a target offset, and a target parameter in response to an image generation condition being satisfied. Furthermore, an effect image of the effect object is drawn according to the determined extension information. Thus, the effect of generating an effect image of an effect object at random is realized, and furthermore, the display effect of the effect image is improved on the basis of ensuring the generation efficiency of the effect image.

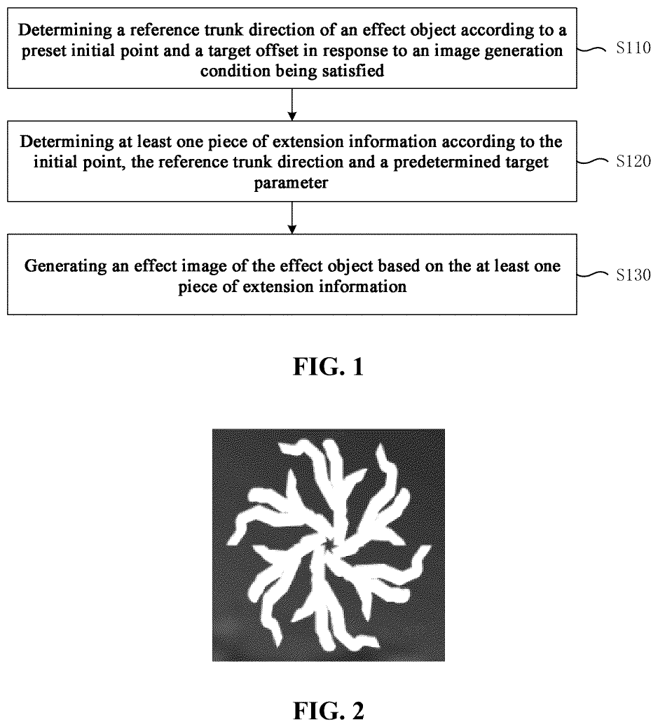

FIG. 1 illustrates a schematic flow diagram of an image generation method in accordance with an embodiment of the present disclosure. The embodiment of the present disclosure is applicable to generating an effect image of an effect object, for example, in the case where the effect object may be an object having a certain growth rule, and the method may be executed by an image generation apparatus, and the apparatus may be realized in the form of software and/or hardware, and optionally, by an electronic device, and the electronic device may be a mobile terminal, a PC end or a server, etc.

As shown in FIG. 1, the method of the present embodiment may specifically include:

S110, determining a reference trunk direction of an effect object according to a predetermined initial point and a target offset in response to an image generation condition being satisfied.

In the present embodiment, the image generation condition may be a predetermined condition that triggers the effect image generation. The image generation condition may be any condition capable of triggering effect image generation. The initial point can be understood as a starting point corresponding to an effect object being generated iteratively, i.e. extending from this point during the iteration. The initial point may be determined randomly or based on a predetermined rule, which is not particularly limited by the embodiments of the present disclosure. The target offset may be understood as a directional offset generated according to a predetermined rule. The target offset may be a randomly generated random offset. Note that the benefit of randomly generating the target offset is that: the randomness of the pattern shape of the final effect image can be ensured, and the interest and diversity of the effect image can be improved. The target offset may be a vector with a direction, i.e. the target offset includes both an offset magnitude and an offset direction. The effect object can be understood as an effect element that can be added in an image or a video. The effect object may be an object with a well-defined growth pattern. Alternatively, effect objects may be snowflakes, paws, branches, etc. The reference trunk direction can be understood as a reference standard on which a trunk direction of the effect object is determined, namely, the trunk direction of the effect object can be determined between the direction and the extension direction corresponding to the initial point.

In practical applications, the reference trunk direction of the effect object can usually be determined only if the image generation condition is satisfied, then the image generation condition may comprise at least one of the following:

The first way may be: triggering a control for generating an effect image corresponding to the effect object.

In the present embodiment, the control for triggering an effect prop may be set in advance, or, an effect generation object which is a control for generating a corresponding effect image, may be set in advance. Also, the set controls may be displayed in an effect prop display page. When it is detected that the user triggers the control for generating the effect image corresponding to the effect object, it can be determined that the effect generation condition is satisfied.

The second way may be: a multimedia data stream comprising a predetermined picture content and/or a predetermined audio clip.

In the present embodiment, the multimedia data stream may be a data stream comprised of at least one media type (e.g. image, text, audio, video, etc.). In embodiments of the present disclosure, the multimedia data stream may comprise an audio stream and/or a video stream. The predetermined picture content can be understood to be predetermined picture content for triggering addition of the effect image. Illustratively, in the case where the effect image is a snowflake pattern, the corresponding predetermined picture content thereof may be a snow scene picture. The predetermined audio clip may be understood to be a predetermined audio clip for triggering addition of the effect image. Illustratively, in the case where the effect image is a claw pattern, the corresponding predetermined audio piece thereof may be an animal vocal audio.

In a practical application, some picture contents may be set as effect trigger picture contents in advance, and some audio clips may also be set as effect trigger audio clips in advance. Furthermore, the multimedia data stream received by a terminal device can be analyzed and processed, and in the case where it is determined that the multimedia data stream comprises the predetermined picture content and/or the predetermined audio clip, it can be determined that the image generation condition is satisfied. Illustratively, in determining that snow scene content is included in the multimedia data stream, the snowflake pattern may be added to the multimedia data stream.

A third way may be: a current environmental parameter matching a predetermined environmental parameter for adding an effect image.

In the present embodiment, the current environmental parameter can be understood as the corresponding environmental parameter upon receiving the effect image generation requirements. The current environmental parameter may comprise a plurality of environmental parameters characterizing the environment to which the terminal device belongs, and optionally may comprise date, weather, etc. The predetermined environmental parameters may be predetermined environmental parameters corresponding to triggering addition of the effect image. Illustratively, in the case where the effect image is the snowflake pattern, the corresponding predetermined environmental parameter may be the date for Christmas or the weather for snowfall.

In practical applications, some link parameters can be set in advance as environmental parameters corresponding to addition of the effect image, and then the predetermined environmental parameters can be determined. Furthermore, the current environmental parameters can be analyzed and processed, and when it is determined that the current environmental parameters match the predetermined environmental parameters with the addition of the effect image, it can be determined that the image generation condition is satisfied. Illustratively, the snowflake pattern may be added upon determining that the date in the current environmental parameter is Christmas.

It should be noted that the image generation condition including the above-mentioned various means is advantageous in that: the diversity of image generation conditions is enhanced, and the intelligence of image generation trigger mechanism is improved.

Furthermore, in response to the image generation condition being satisfied, the reference trunk direction of the effect object can be determined according to the initial point and the target offset. It should be noted that the target offset is the distance between a straight line corresponding to the reference trunk direction and an initial extension straight line corresponding to the initial point, and therefore when the reference trunk direction is determined based on the initial point and the target offset, the direction of the initial extension straight line, i.e. the initial direction starting from the initial point, can also be determined. Further, the reference trunk direction may be determined from the initial point, the initial direction and the target offset.

Optionally, determining the reference trunk direction of the effect object according to the predetermined initial point and the target offset, comprising: determining the reference trunk direction of the effect object according to the predetermined initial point, the initial direction and the target offset.

In the present embodiment, the initial direction may be understood as a direction vector starting from the initial point, and the direction vector may be set on the basis of determining the initial point.

In practice, the predetermined initial point and the initial direction may be determined and the target offset may be randomly determined. Furthermore, the offset can be executed according to an offset size and an offset direction in the target offset on the basis of the initial direction to obtain the offset direction, and the offset direction can be used as the reference trunk direction of the effect object.

S120, determining at least one piece of extension information according to the initial point, the reference trunk direction and a predetermined target parameter.

In the present embodiment, the target parameter may be understood as a parameter for determining the effect image. The target parameter may be a parameter based on an array characterization of any dimension, alternatively a two-dimensional array. The target parameter may also be a randomly generated parameter, in which case the target parameter may be a set of random numbers. The extension information can be understood as effect generation information on which the effect object is generated, and can also be understood as information characterizing the extension of the effect object. The extension information comprises an extension position and a corresponding target extension direction. The extension position is understood to be a position corresponding to the end of the iteration during this iteration. The target extension direction may be understood as a growth direction of the special object, which may be determined from the initial point and the extension position. It should be noted that the effect object may generally be composed of trunks and/or branches, and therefore, the trunk extension information and/or the branch extension information may be included in the determined at least one piece of extension information. The trunk extension information can be understood as information characterizing the trunk extension of the effect object. The branch extension information can be understood as information characterizing the branch extension of an effect object.

In practice, the target parameter for generating the effect image may also be determined before determining at least one piece of extension information based on the initial point, the reference trunk direction and the target parameter.

Optionally, determining the target parameter for generating the effect image, comprising: determining the target parameter according to a predetermined interval between adjacent video frames, position information of at least one element in an initialization parameter, and a target function.

In the present embodiment, a frame rate of the video frame may be obtained and the frame rate may be inverted to obtain the inverse of the frame rate. Further, the resulting reciprocal may be taken as the interval between adjacent video frames. The initialization parameter may be understood as an array of initial values. The dimension of the initialization parameter coincides with the dimension of the target parameter. It should be noted that the dimension size of the initialization parameter (or the target parameter) can determine the fineness of the finally generated effect image, i.e. the difference between a straight line and a curved line in the effect image can be clearly perceived. The position information of an element can be understood as the number of rows and columns the element is in in the array. The target function may be understood as a predetermined function for determining the objective parameter. The target parameter includes at least one pseudo-random number. A pseudo-random number refers to a sequence of random numbers generated by an algorithm. The pseudo-random number is not a true random number, but has statistical characteristics similar to a random number. The pseudo-random number may range from [0, 1].

In practice, the initialization parameters may be determined first and the interval between the adjacent video frames are determined. Furthermore, with regard to each element in the initialization parameter, position information of the current element in the initialization parameter can be acquired, and the position information and the interval are input into the target function, i.e. a parameter corresponding to the current element can be output. Further, according to the position information of the current element in the initialization parameter, the parameter can be updated to the initialization parameter so as to replace the current element with the corresponding parameter. Further, each element in determining the initialization parameter is replaced with a corresponding parameter, and the array obtained at this time can be taken as the target parameter. Be advantageously arranged such that the correlation between the target parameter and the video frames is improved, and then the effect that the generated target parameter provides the data basis for subsequent generation of the effect image is realized, and the finally generated effect image can be switched according to the switching frequency of the video frame.

Further, after determining the target parameter, the extension information may be determined based on the initial point, the target parameter and the reference trunk direction. It is noted that the advantage of determining the extension information based on the target parameter comprising the pseudo-random number is that: based on the pseudo-random number in the target parameters, the extension rule of the effect object can be reflected, and meanwhile, randomness of a pattern shape of the effect image can be guaranteed, and pattern diversity of the effect image can be improved.

In practice, at least one pseudo-random number may be included in the target parameter, with each pseudo-random number having corresponding position information. The effect object may be the effect pattern extending from the initial point to the outside of a region where the initial point is located. Therefore, in a practical application, at least one parameter may be obtained by taking the initial point as one of the elements in the target parameter, and determining a parameter of at least one vicinity position adjacent to the position according to the position of the element in the target parameter. Further, the target number that satisfies the effect object generation requirement may be determined from the at least one parameter. Furthermore, the vicinity position of the target number can be determined, and the extension information can be determined from the vicinity position, the initial point and the reference trunk direction. Illustratively, assuming that the target parameter is an N×N array, i.e.

$$[ \begin{matrix}{a}_{1 \times 1} & … & {a}_{1 \times N} \\ ⋮ & ⋱ & ⋮ \\ {a}_{N \times 1} & … & {a}_{N \times N}\end{matrix} ] ,$$

the position of the initial point within the target parameter is the third row and the fourth column, the initial point may be α_{3×4}. Further, the vicinity may be determined to be 1, and the parameter of the at least one vicinity position corresponding to the initial point may include α_{2×3}, α_{2×4}, α_{2×5}, α_{3×3}, α_{3×5}, α_{4×3}, α_{4×4} and α_{4×5}.

It is to be noted that, in the case where there is no target number satisfying the effect object generation requirement among the determined at least one parameter, a determination range of the vicinity position can be expanded, and a parameter of the at least one vicinity position with the expanded range can be determined. Furthermore, the target number satisfying the effect object generation requirement can be selected from at least one parameter obtained at this time. Illustratively, with continued reference to the above example, if the target number cannot be determined from the eight parameters determined in the case where the vicinity is 1, the vicinity may be determined to be 2, and the parameter of at least one vicinity position corresponding to the initial point may include α_{1×2}, α_{1×3}, α_{1×4}, α_{1×5}, α_{1×6}, α_{2×2}, α_{2×6}, α_{3×2}, α_{3×6}, α_{4×2}, α_{4×6}, α_{5×2}, α_{5×3}, α_{5×4}, α_{5×5} and α_{5×6}.

It should also be noted that the number of target numbers determined may be one or more. In general, a branch can be extended on the basis of a trunk, and in the case where the number of target numbers is one, the determined extension information can be trunk extension information, namely, a trunk extension direction and a trunk extension position in the trunk extension information can be determined according to the vicinity position, the initial point and the reference trunk direction of the target numbers; in the case where the number of target numbers is plural, the determined extension information may include the trunk extension information and the branch extension information.

S130, generating an effect image of the effect object based on the at least one piece of extension information.

In the present embodiment, the effect images may be the effect elements that include effect objects and can be added in other images. The effect image may comprise any pattern of trunks and/or branches, and optionally may comprise the snowflake pattern, the claw pattern, and the branch pattern, etc. Illustratively, as shown in FIG. 2, the effect image of the snowflake pattern.

In practice, the at least one piece of extension information is determined based on the initial point, and accordingly, the at least one piece of extension information may determine at least part of the pattern of the effect object. Thus, after determining the at least one piece of extension information, the local pattern of the effect object can be determined based on the at least one piece of extension information. Further, a partial image in the effect image may be determined according to the local pattern. Furthermore, in order to ensure the integrity of the effect image, the part of the image can be rotated with the initial point as the rotation center, and the image obtained by 360° rotation is taken as the effect image.

In the technical solution of the embodiments of the present disclosure, the reference trunk direction of the effect object is by determined according to the predetermined initial point and the target offset in response to the image generation condition being satisfied, and at least one piece of extension information is determined according to the initial point, the reference trunk direction and a predetermined target parameter, and finally the effect image of the effect object is generated based on the at least one piece of extension information, solving the problems of a certain limitation of a pattern style of the generated effect image of the effect object and a relatively single display effect of the effect image in the related art, achieving the effect of generating effect images of effect objects randomly, and improving the display effect of effect images on the basis of ensuring the efficiency of generating effect images.

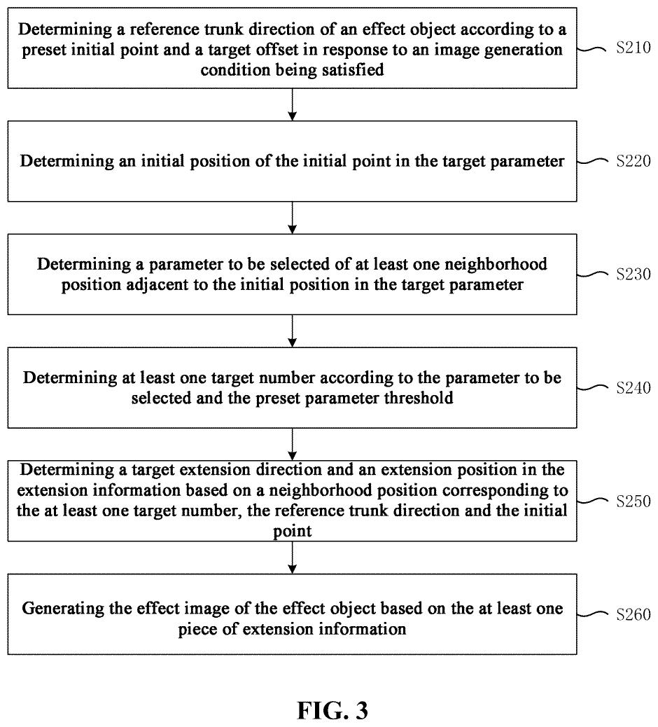

FIG. 3 illustrates a schematic flow diagram of another image generation method in accordance with an embodiment of the present disclosure. The technical solution of the present embodiment, on the basis of the above-mentioned embodiment, determines the initial position of the initial point within the target parameter, and determines the parameter to be selected of at least one vicinity position adjacent to the initial position in the target parameter, and further determines the target number according to the parameter to be selected, and determines the extension information based on the vicinity position corresponding to the target number, the reference trunk direction and the initial point. Please see depiction of the present embodiment for the specific implementation. The same or similar technical features to those of the previous embodiments will not be described again.

As shown in FIG. 3, the method of the present embodiment may specifically include:

S210, determining a reference trunk direction of an effect object according to a predetermined initial point and a target offset in response to an image generation condition being satisfied.

S220, determining the initial position of the initial point within the target parameter.

In the present embodiment, the initial position can be understood as a row and column position information of the initial point within the target parameter.

In practical applications, in the case of obtaining the target parameter, the position information of an element can be randomly determined in the target parameter. Further, the position information may be regarded as the initial position of the initial point within the target parameter.

S230 determining, among the target parameter, a parameter to be selected of at least one vicinity position adjacent to the initial position.

In the present embodiment, the vicinity position may be a position determined based on the vicinity corresponding to the initial position. The vicinity corresponding to the initial position refers to a region constructed with the initial position as the center and with a predetermined distance. The vicinity may include a variety of vicinitys and, optionally, may include a 4-vicinity, a D-vicinity, or an 8-vicinity, etc. As an example, assuming that the initial position is (x,y), and the predetermined distance is 1, and four vicinity positions of the 4-vicinity corresponding to the initial position may comprise (x,y−1), (x,y+1), (x−1,y) and (x+1,y), and the four vicinity positions of the D-vicinity corresponding to the initial position may comprise (x+1,y+1), (x+1,y−1), (x−1,y+1) and (x−1,y−1); the eight vicinity positions of the 8-vicinity corresponding to the initial position may include (x,y−1), (x,y+1), (x−1,y), (x+1,y), (x+1,y+1), (x+1,y−1), (x−1,y+1) and (x−1,y−1). In the target parameter, parameter at each vicinity position is the parameter to be selected.

In practical applications, after the initial position is determined, a distance can be determined according to a predetermined determined vicinity, and a vicinity centered on the initial position is determined. Further, at least one vicinity position may be determined from the vicinity. Further, among the target parameters, a parameter corresponding to each vicinity position may be determined, and further, at least one parameter to be selected may be obtained.

Illustratively, assuming the initial position of the initial point within the target parameter is the third row and the fourth column, the parameter corresponding to the initial point may be α_{3×4}. Further, the vicinity may be determined to be 1, and the parameter to be selected of at least one vicinity position adjacent to the initial position may include α_{2×3}, α_{2×4}, α_{2×5}, α_{3×3}, α_{3×5}, α_{4×3}, α_{4×4} and α_{4×5}.

S240, determining at least one target number according to the parameter to be selected and the predetermined parameter threshold.

In the present embodiment, the predetermined parameter threshold may be any value in an interval of values corresponding to each parameter in the target parameter, and may optionally be 0.5.

In practical applications, after at least one parameter to be selected is determined, each parameter to be selected can be compared with the predetermined parameter threshold, and then at least one target number can be determined from the parameters to be selected according to the comparison result.

It should be noted that the finally determined target number is used for determining the extension information of the effect object, and before the extension information is determined, the position information between the extension information and the initial point can be predetermined, namely, whether the finally determined extension information is expected to be located above or below the horizontal line where the initial point is located, and a constraint condition can be determined based on the expected position information. Furthermore, when the target number is determined from the parameter to be selected, in addition to depending on the size relationship between the parameter to be selected and the predetermined parameter threshold, the parameter to be selected can also be filtered first according a predetermined constraint condition. Furthermore, the finally filtered parameter to be selected can be taken as the target number.

Optionally, at least one target number is determined according to the parameter to be selected and the predetermined parameter threshold, comprising: determining a parameter to be used according to a first constraint condition and a vicinity position of the parameter to be selected; taking the parameter to be used greater than the predetermined parameter threshold as the target number.

The first constraint condition is a constraint condition for constraining position information of the target number in the target parameter. Alternatively, the first constraint may comprise that the position information of the target number in the target parameter is above or below the row where the initial position is located.

In a practical application, after at least one parameter to be selected is determined, the position information of each parameter to be selected in the target parameter can be determined, i.e. the vicinity position of each parameter to be selected is determined. Then, each vicinity position can be filtered according to the first constraint condition, and vicinity positions satisfying the first constraint condition can be filtered out, and a parameter to be selected corresponding to the filtered vicinity position can be taken as the parameter to be used. Further, each parameter to be used may be compared with a predetermined parameter threshold, and the parameter to be used greater than the predetermined parameter threshold may be used as the target number. Be advantageously arranged such that the effect of making the finally obtained target number satisfy the expected extension direction of the effect object is realized, and furthermore, the matching degree between the display effect of the effect image of the effect object and the real display effect is improved.

Illustratively, with continued reference to the above example, the parameter corresponding to the initial position may be α_{3×4}. Further, the parameters to be selected for at least one vicinity position adjacent to the initial position may include α_{2×3}, α_{2×4}, α_{2×5}, α_{3×3}, α_{3×5}, α_{4×3}, α_{4×4} and α_{4×5}. Assuming that the first constraint condition is that the position information of the constraint target number is above the row where the initial position is located, the parameter to be used obtained after filtering the parameters to be selected according to the first constraint condition can be (2×3, α_{2×4}, α_{2×5}, α_{3×3} and α_{3×5}, wherein, α_{2×3} is 0.4, α_{2×4} is 0.6, α_{2×5} is 0.8, α_{3×3} is 0.3 and α_{3×5} is 0.4. Further, assuming that the predetermined parameter threshold is 0.5, the finally obtained target number is α_{2×4} and α_{2×5}.

It should be noted that when the target number is determined from at least one parameter to be selected, the vicinity position of each parameter to be selected may also be filtered without depending on the first constraint condition, that is to say, after at least one parameter to be selected is determined, each parameter to be selected may be directly compared with the predetermined parameter threshold, and the parameter to be selected greater than the predetermined parameter threshold may be taken as the target number.

Furthermore, if there is the target number in at least one parameter to be selected, the number of the target numbers may be one or more; if there is no target number in at least one parameter to be selected, the parameter to be selected of at least one vicinity position corresponding to the initial position can be re-determined, and the target number is determined in the re-determined at least one parameter to be selected, and the process of re-determining the parameter to be selected can refer to the contents described in the step S120, and the embodiments of the present disclosure will not be described in detail here.

S250, determining a target extension direction and an extension position contained in the extension information based on a vicinity position corresponding to the at least one target number, the reference trunk direction and the initial point.

In the present embodiment, after at least one target number is determined, the position information of each target in the target parameter can be determined, and the position information is taken as the vicinity position corresponding to the target number.

Note that the number of the at least one target number may be one or more. In the case where the number of target numbers is one, the determined extension information may comprise trunk extension information; in the case where the number of target numbers is plural, the determined extension information may include the trunk extension information and the branch extension information. The determination process of the extension information corresponding to one target number and a plurality of target numbers will be described below.

Optionally, the target number comprises one, and the extension information comprises the trunk extension information. Determining the extension direction and the extension position of the target in the extension information based on the vicinity position corresponding to the at least one target number, the reference trunk direction and the initial point comprises: taking the vicinity position of the target number in the target parameter as the extension position in the trunk extension information; determining the target trunk extension direction and target trunk extension length of effect object according to the extension position and the initial point.

In practical applications, in the case where the number of targets is one, the vicinity position of the number of targets in the target parameter can be determined, and the vicinity position is taken as the extension position in the trunk extension information, i.e. the position where a trunk extension end point is located. Further, the initial point may be taken as an extension start point, the extension position may be taken as the extension end point, and a connecting line between the extension start point and the extension end point may be determined, and a direction pointing from the extension start point to the extension end point may be taken as the target trunk extension direction, and a length of the connecting line may be taken as a target trunk extension length. Be advantageously arranged such that the effect of determining the trunk extension information of effect object based on target parameters is realized, and the effect of reflecting the random generation of the effect object on the basis of ensuring the trunk extension trend is realized.

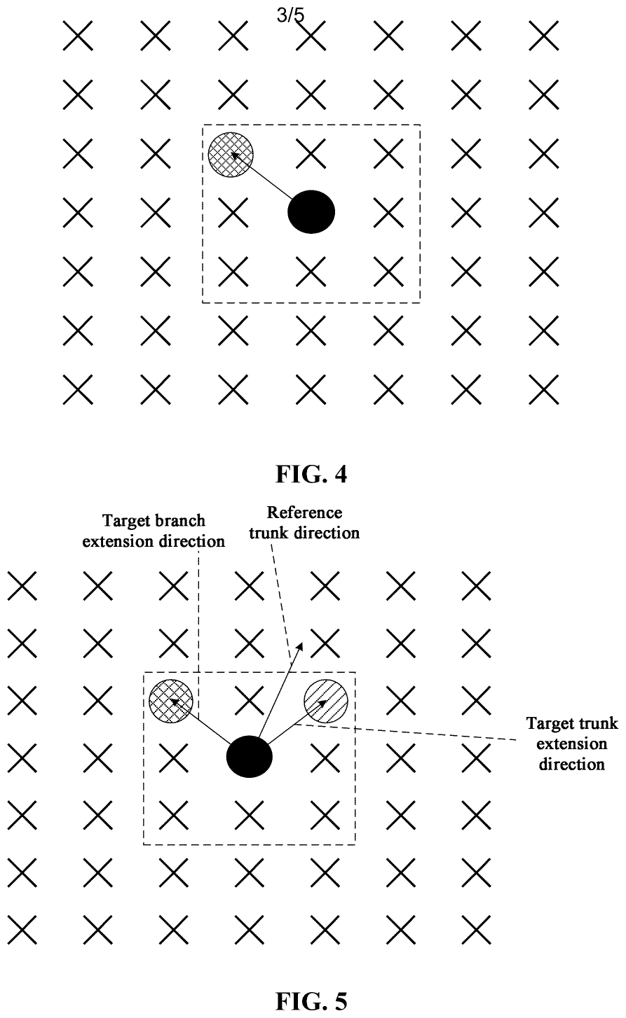

Illustratively, as shown in FIG. 4, assuming that the center point of the dashed box in FIG. 4 is the initial point, the parameter included in the dashed box (except for the initial point) is the parameter to be selected for at least one vicinity position adjacent to the initial position. Furthermore, assuming that the finally determined target number is a point filled by a grid in the dashed box, the vicinity position of the point in the target parameter is the extension position, and the arrow direction shown in FIG. 4 is the target trunk extension direction, and the length of the connecting line between the initial point and the point is the target trunk extension length.

Optionally, the target number may comprise a plurality of target numbers and the extension information comprises the trunk extension information and the branch extension information.

Determining the target extension direction and the target extension position contained in the extension information based on the vicinity position corresponding to the at least one target number, the reference trunk direction and the initial point comprises: determining relative deflection angles between connecting lines between the initial point and the vicinity positions corresponding to a plurality of the target numbers and the reference trunk direction; taking the vicinity position corresponding to a minimum relative deflection angle as the trunk extension position in the trunk extension information, and determining the target trunk extension direction in the trunk extension information according to the trunk extension position and the initial point; taking the vicinity position corresponding to other target number as the branch extension position in branch extension information, and determining the target branch extension direction in the branch extension information according to the branch extension position and the initial point.

In the present embodiment, the trunk extension position is a position corresponding to the extension end point of the trunk determined this time. The target trunk extension direction is the direction from the initial point to the trunk extension position. The branch extension position may be a position corresponding to the extension end point of the branch determined at this time. The target branch extension direction is a direction from the initial point to the branch extension position.

In practical applications, when the target number comprises a plurality of target numbers, the connecting line between the initial point and the vicinity position corresponding to each target number can be respectively determined, and then a plurality of connecting lines can be obtained. Further, the angle between each line and the reference trunk direction may be determined separately and may be taken as the relative deflection angle. Further, a plurality of relative deflection angles can be obtained. Then, the minimum relative deflection angle among the plurality of relative deflection angles can be determined, and a target number corresponding to the relative deflection angles can be determined, and a vicinity position corresponding to the target number can be taken as the trunk extension position in the trunk extension information. Thereafter, the direction in which the starting point point to the trunk extension position may be taken as the target trunk extension direction. Furthermore, for other target numbers except the target number corresponding to the minimum relative deflection angle, the vicinity position corresponding to each other target number may be taken as the branch extension position, and the direction in which the initial point points to the branch extension position may be taken as the target branch extension direction in the branch extension information. Be advantageously arranged such that the effect of determining the trunk extension information and branch extension information of effect objects based on target parameters is realized, and the effect of representing the random generation of effect objects on the basis of ensuring the trunk extension trend and branch extension trend of effect objects is realized.

Illustratively, with reference to FIG. 5, assume that the target number A is the point filled with the grid in the dashed box, and the target number B is the point filled with diagonal lines, and the initial point is the center point in the dashed box. It can be seen from FIG. 5 that, the relative deflection angles between the connecting lines between the initial point and the vicinity position of the target number A, and the reference trunk direction, is larger than the relative deflection angle between the connecting line between the initial point and the vicinity position of the target number B, and the reference trunk direction, then the vicinity position of the target number B can be taken as the trunk extension position, and the direction in which the initial point points to the target number B can be taken as the target trunk extension direction; the vicinity position of the target number A is taken as the branch extension position, and the direction in which the initial point points to the target number A is taken as the target branch extension direction.

It should be noted that the above-mentioned process of determining the extension information can be an iterative process in an effect object generation process, and after the extension information is determined, the next iteration can be started until the finally obtained extension position reaches the predetermined extension boundary, and the iteration can be stopped, and finally the at least one piece of extension information for generating the effect image of the effect object is obtained.

Based on this, after the extension position is determined, the method further comprises: taking a point corresponding to the extension position as the initial point, and repeatedly executing the step of determining at least one piece of extension information according to the initial point, the reference trunk direction and the predetermined target parameter.

In a practical application, after the extension position in the trunk extension information is determined, or alternatively, the trunk extension position in the trunk extension information and the branch extension position in the branch extension information are determined, a point corresponding to the extension position may be taken as the starting point, and the step of determining at least one piece of extension information according to the starting point, the reference trunk direction and the target parameter is repeatedly executed. Furthermore, until the finally obtained extension information reaches a predetermined iteration stop condition, the extension information determined in at least one iteration process can be obtained. Be advantageously arranged such that the effect of iteratively determining the trunk extension information and/or branch extension information is realized, and then the effect of characterizing the growth law of effect objects by iteratively determining the extension information is achieved.

In practical applications, the corresponding predetermined iteration stop conditions are different for the trunk extension information and the branch extension information. In the case where it is determined that the trunk extension information reaches the predetermined iteration stop condition corresponding thereto, the step of determining the trunk extension information is stopped, and at this moment, if the branch extension information does not reach the predetermined iteration stop condition corresponding thereto, the step of determining the branch extension information can be continued to be executed; in the case where it is determined that the branch extension information reaches the predetermined iteration stop condition corresponding thereto, the step of determining the branch extension information can be stopped, and at this moment, if the trunk extension information does not reach the predetermined iteration stop condition corresponding thereto, the step of determining the trunk extension information can be continued to be executed. The predetermined iteration stop condition of the trunk extension information and the predetermined iteration stop condition of the branch extension information may be described below, respectively.

Optionally, the step of determining the trunk extension information in the extension information is stopped when the extension position in the trunk extension information in the at least one piece of extension information reaches the predetermined extension boundary.

In the present embodiment, the predetermined extension boundary may be a predetermined effect object extension boundary.

In practical applications, in the case where the extension information comprises the trunk extension information, if the extension position in the trunk extension information reaches the predetermined extension boundary, the step of determining the trunk extension information is stopped; in the case where the extension information comprises the trunk extension information and the branch extension information, if the trunk extension position in the trunk extension information reaches the predetermined extension boundary, the step of determining the trunk extension information is stopped. Be advantageously arranged such that the effect of limiting the length of the trunk extension of the effect object is realized, and the effect of determining the trunk extension information within a predetermined range is realized, and furthermore, the effect of matching the display shape of the effect image of the effect object with the real display form is realized.

Optionally, the step of determining the branch extension information in the extension information is stopped when a number of executions of the extension information belonging to a same branch in the at least one piece of extension information reaches the predetermined number threshold.

In the present embodiment, the number of executions of the extension information belonging to a same branch may be the number of executions of the step of determining the extension information in the same branch, i.e. the number of iterations of the extension information on the same branch. The predetermined number threshold may be any number of executions set in advance.

In practical applications, with regard to the branch extension information, for each determined branch, the corresponding initial execution times thereof may be the number corresponding to the predetermined number threshold before the step of determining extension information is not executed on the current branch. Further, the step of determining the extension information is executed once on the current branch, and the initial execution times of which may be reduced by one. When it is determined that the initial execution times is 0, it can be determined that the execution times of the extension information belonging to the current branch reaches the predetermined number threshold. Further, the step of determining the branch extension information is stopped.

S260, generating an effect image of the effect object based on the at least one piece of extension information.

The technical solution of an embodiment of the present disclosure determines the reference trunk direction of the effect object according to the predetermined initial point and the target offset in response to the image generation condition being satisfied, then determines the initial position of the initial point within the target parameter, then determines the parameter to be selected in at least one vicinity position adjacent to the initial position in the target parameter, then determines at least one target number according to the parameter to be selected and the predetermined parameter threshold, and then determines the extension direction and the extension position of the target in the extension information based on the vicinity position corresponding to the at least one target number, the reference trunk direction and the initial point, and finally, generates the effect image of the effect object based on at least one piece of extension information. As such, the effect of determining the extension information and the branch extension of the effect object based on the target parameter, and furthermore, the effect of increasing the random generation of the effect object on the basis of ensuring the trunk extension trend and branch extension trend of the effect object is realized.

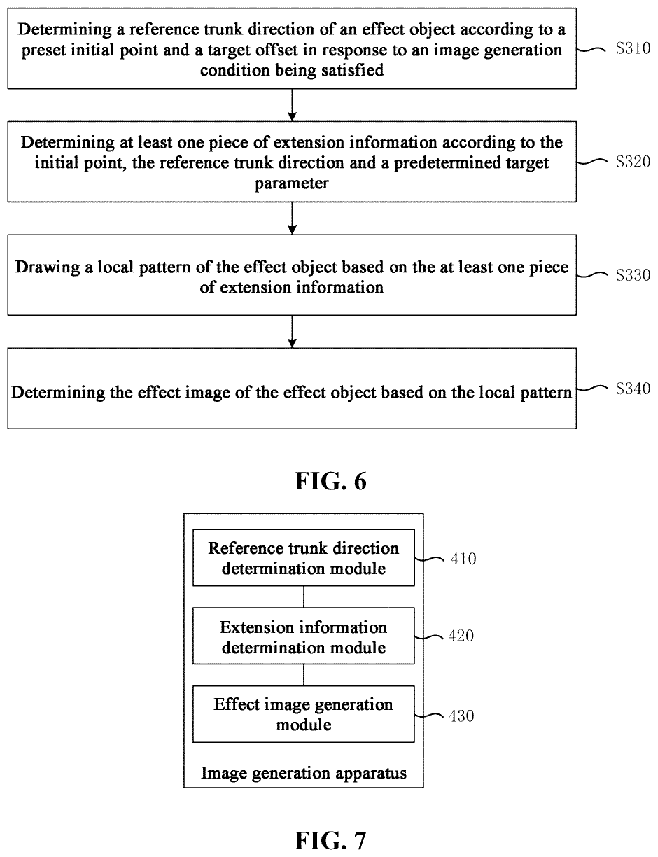

FIG. 6 illustrates a flow diagram of another image generation method in accordance with an embodiment of the present disclosure. The technical solution of the present embodiment draws a local pattern of the effect object based on at least one piece of extension information on the basis of the above-mentioned embodiment, and determines the effect image of the effect object based on the local pattern. Detailed implementation can be found in the description of the present embodiment. Here, the same or similar technical features to those of the previous embodiments will not be described again.

As shown in FIG. 6, the method of the present embodiment may specifically include:

S310, determining a reference trunk direction of an effect object according to a predetermined initial point and a target offset in response to an image generation condition being satisfied.

S320 determining at least one piece of extension information according to the initial point, the reference trunk direction and the predetermined target parameter.

S330, drawing an effect image of the effect object based on the at least one piece of extension information.

In the present embodiment, a local pattern can be understood as at least part of an overall pattern to which the effect object corresponds.

In practical applications, the determined at least one piece of extension information is information composed of the plurality of connecting lines with the initial point as the starting point; and in order to make the effect display effect of the finally generated effect object closer to the real display effect of the corresponding entity object, an area to be filled can be determined based on the initial point and the at least one piece of extension information, and then filling processing can be executed on the area so as to obtain a local pattern of the effect object.

Optionally, drawing the local pattern of the effect object based on the at least one piece of extension information comprises: determining a target area surrounding the initial point and the extension position based on the initial point, the extension position contained in the extension information and a predetermined radius; filling the target area according to a predetermined width, and generating the local pattern of the effect object.

In the present embodiment, the predetermined radius may be any value. The predetermined width may also be any value. It should be noted that the predetermined radius corresponding to the initial point and the predetermined radius corresponding to the extension position may be the same or different, and the embodiments of the present disclosure are not particularly limited.

In practical applications, a first surrounding area corresponding to the initial point may be drawn with the initial point as the center and the corresponding predetermined radius as the radius, and a second surrounding area corresponding to the extension position may be drawn with the extension position as the center and the corresponding predetermined radius as the radius. Alternatively, the shape of the first surrounding area and the second surrounding area may be circular or elliptical.

Furthermore, a tangent line between the first surrounding area and the second surrounding area can be determined, and two tangent lines can be obtained, and a tangent point between each tangent line and the first surrounding area is determined, i.e. two tangent points corresponding to the first surrounding area can be obtained, and a tangent point between each tangent line and the second surrounding area is determined, i.e. two tangent points corresponding to the second surrounding area can be obtained. Further, two tangent points corresponding to the first surrounding region and two tangent points corresponding to the second surrounding region may be connected, and the region, the first surrounding region and the second surrounding region obtained after the connection may be taken as a target region surrounding the initial point and the extension position.

Further, the filling processing may be executed on the target area according to the predetermined width so as to fill a pixel value of a corresponding pixel point in the target area into a predetermined pixel value. Furthermore, the pattern obtained after filling can be used as the local pattern of the effect object. Be advantageously arranged such that the effect of drawing the local pattern of the effect object based on extension information is realized, pattern basis for drawing the overall pattern of the effect object is given, and the efficiency of generating the effect image of the effect object is improved.

S340 determining the effect image of the effect object based on the local pattern.

In the present embodiment, after the local pattern is determined, the effect image of the effect object may be generated based on the local pattern.

In practical applications, there may be a certain difference between the drawn local pattern and the expected effect of the effect object, and therefore, after the local pattern is obtained, the local pattern can be clipped, and the effect image of the effect object can be determined based on the clipped pattern.

Optionally, determining the effect image of the effect object based on the local pattern, comprises: cutting the local pattern based on a predetermined cutting shape to obtain a pattern to be concatenated; obtaining the effect image of the effect object by concatenating the pattern to be concatenated.

In the present embodiment, the predetermined cutting shape may be a predetermined shape according to which the local pattern is cut. The predetermined cutting shape may be any shape including vertices. Alternatively, the predetermined cutting shape may comprise a polygon, for example a triangle.

In practical applications, after the local pattern is obtained, the initial point within the local pattern can be taken as one of vertices in the predetermined cutting shape, and the local pattern is cut based on the predetermined cutting shape; and the local pattern with the shape of the predetermined cutting shape obtained by cutting can be taken as a pattern to be concatenated. Be advantageously arranged such that the similarity between the pattern shape and a real display shape of the finally generated effect image is enhanced, and the generation convenience of the effect image is improved.

Optionally, in the case where the predetermined cutting shape is a polygon, a local pattern cutting processing is executed on the basis of the predetermined cutting shape to obtain the pattern to be concatenated, comprises: cutting the local pattern according to a polygon to obtain the pattern to be concatenated; stretching the pattern to be concatenated when the polygon is a non-regular polygon to update the pattern to be concatenated.

In practical applications, the initial point within a local pattern can be taken as the vertex in the polygon, and the local pattern is cut according to the polygon, and the cutting pattern can be taken as the pattern to be concatenated. If the polygon is a regular polygon, the pattern to be concatenated obtained at this time can be taken as the finally obtained pattern to be concatenated. If the polygon is a non-regular polygon, the to-be-concatenated pattern can be stretched to correct the angle of the pattern to be concatenated. Furthermore, the pattern to be concatenated obtained after the processing can be used as the final pattern to be concatenated. Be advantageously arranged such that the effect of making the pattern shape of the obtained pattern to be concatenated consistent with a regular polygon is realized, and furthermore, subsequent concatenating processing on the pattern to be concatenated is facilitated, and the generation efficiency of the effect image is improved.

In the present embodiment, the pattern to be concatenated is a pattern comprising the initial point and having a shape of the predetermined cutting shape, and is the local pattern corresponding to the effect object; in order to obtain a complete pattern corresponding to the effect object and generate the effect image based on the complete pattern, a rotation processing can be executed on the pattern to be concatenated based on the initial point, and then the effect image of the effect object can be obtained.

Optionally, obtaining the effect image of the effect object by concatenating the pattern to be concatenated, comprises: taking the initial point of the pattern to be concatenated as a rotation center, and rotating the pattern to be concatenated to obtain the effect image of the effect object.

In practical applications, after the pattern to be concatenated is obtained, the initial point of the pattern to be concatenated can be taken as a rotation center, and rotation processing can be executed on the pattern to be concatenated, and the pattern obtained after rotation can be taken as an effect image of an effect object. By way of example, if the predetermined cutting shape corresponding to the pattern to be concatenated is a regular triangle, the pattern shape corresponding to the effect image may be a regular hexagon. Be advantageously arranged such that the efficiency of effect image generation is improved, and the convenience of effect image generation is improved.

In the technical solution of an embodiment of the present disclosure, the reference trunk direction of the effect object is determined according to the predetermined initial point and the target offset in response to the image generation condition being satisfied, and the at least one piece of extension information is determined according to the initial point, the reference trunk direction and the predetermined target parameter, and finally the local pattern of the effect object is drawn based on the at least one piece of extension information, and the effect image of the effect object is determined based on the local pattern, realizing the effect of drawing the local pattern of the effect object based on the extension information, providing a pattern basis for drawing the overall pattern of effect objects subsequently, and improving the efficiency of generating the effect image of the effect object.

FIG. 7 illustrates a schematic configuration diagram of an image generation apparatus in accordance with an embodiment of the present disclosure. As shown in FIG. 7, the apparatus comprises: a reference trunk direction determination module 410, an extension information determination module 420 and an effect image generation module 430.

The reference trunk direction determination module 410 is used for determining the reference trunk direction of the effect object according to the predetermined initial point and the target offset in response to the image generation condition being satisfied; the extension information determination module 420 is used for determining at least one piece of extension information according to the initial point, the reference trunk direction and the predetermined target parameter, wherein the extension information comprises the extension position and the corresponding target extension direction; the effect image generation module 430 is used for generating an effect image of the effect object based on the at least one piece of extension information.

On the basis of the above-mentioned optional technical solutions, optionally, the apparatus further comprises: a target parameter determination module.

The target parameter determination module is used for determining the target parameter for generating the effect image;

The target parameter determination module includes: a target parameter determination unit.

The target parameter determination unit is used for determining the target parameter according to the predetermined interval between adjacent video frames, position information of at least one element in the initialization parameter and the target function.

On the basis of the above-mentioned alternatives, optionally, the target parameter comprises at least one pseudo-random number.

On the basis of the above-mentioned alternative technical solutions, optionally, the image generation condition comprises at least one of the following:
triggering the control for generating the effect image corresponding to the effect object;
the multimedia data stream comprising the predetermined picture content and/or a predetermined audio clip;
the current environmental parameter matching the predetermined environmental parameter for adding an effect image.

On the basis of the above-mentioned optional technical solutions, optionally, the extension information determination module 420 comprises: an initial position determination unit, a parameter to be selected determination unit, a target number determination unit and an extension information determination unit.

The initial position determination unit is used for determining the initial position of the initial point within the target parameter;

The parameter to be selected determination unit is used for determining the parameter to be selected in at least one vicinity position adjacent to the initial position in the target parameter;

The target number determination unit is used for determining at least one target number according to the parameter to be selected and the predetermined parameter threshold;

The extension information determination unit is used for determining the target extension direction and the extension position contained in the extension information based on the vicinity position corresponding to the at least one target number, the reference trunk direction and the initial point.

On the basis of the above-mentioned optional technical solutions, optionally, the target number determination unit comprises: a parameter determination subunit and a target number determination subunit are to be used.

The parameter to be used determination subunit is used for determining a parameter to be used according to a first constraint condition and a vicinity position of the parameter to be selected; the first constraint condition is a constraint condition is used for constraining position information of the target number in the target parameter;

The target number determination subunit is used for taking the parameter to be used which is greater than the predetermined parameter threshold as the target number.

On the basis of the above-mentioned optional technical solutions, optionally, the target number comprises one, the extension information comprises the trunk extension information, and the extension information determination unit comprises: an extension position determination subunit and a trunk extension information determination subunit.

The extension position determination subunit is used for taking the vicinity position of the target number in the target parameter as the extension position in the trunk extension information;

The trunk extension information determination subunit is used for determining the target trunk extension direction and the target trunk extension length of the effect object according to the extension position and the initial point.

On the basis of the above-mentioned optional technical solutions, optionally, the target number comprises a plurality of target numbers, the extension information comprises the trunk extension information and the branch extension information, and the extension information determination unit comprises: a relative deflection angle determination subunit, a target trunk extension direction determination subunit and a target branch extension direction determination subunit.

The relative deflection angle determination subunit is used for determining relative deflection angles between connecting lines between the initial point and vicinity positions corresponding to a plurality of the target numbers and the reference trunk direction;

The target trunk extension direction determination subunit is used for taking a vicinity position corresponding to a minimum relative deflection angle as a trunk extension position in the trunk extension information, and determining a target trunk extension direction in the trunk extension information according to the trunk extension position and the initial point;

The target branch extension direction determination subunit is used for taking the vicinity position corresponding to other target number as the branch extension position in branch extension information, and determining the target branch extension direction in the branch extension information according to the branch extension position and the initial point.

On the basis of the above-mentioned optional technical solutions, optionally, the device further comprises: a repeat execution module.

The repeat execution module is used for, after determining the extension position, taking the point corresponding to the extension position as the initial point, and repeatedly executing the step of determining at least one piece of extension information according to the initial point, the reference trunk direction and the predetermined target parameter.

On the basis of the above-mentioned optional technical solutions, optionally, the device further comprises: a first stop execution module and a second stop execution module.

The first stop execution module is used for stopping the execution of the step of determining the trunk extension information in the extension information when the extension position in the trunk extension information in the at least one piece of extension information reaches a predetermined extension boundary;

The second stop execution module is used for stopping the execution of the step of determining the branch extension information in the at least one piece of extension information when the number of executions of the extension information belonging to the same branch in the at least one piece of extension information reaches the predetermined number threshold.

On the basis of the above-mentioned optional technical solutions, optionally, the effect image generation module 430 comprises: a local pattern drawing submodule and an effect image determination submodule.

The local pattern drawing submodule is used for drawing the local pattern of the effect object based on the at least one piece of extension information;

The effect image determination submodule is used for determining the effect image of the effect object based on the local pattern.

On the basis of the above-mentioned optional technical solutions, optionally, the local pattern drawing submodule comprises: a target area determination unit and a local pattern generation unit.

The target area determination unit is used for determining the target area surrounding the initial point and the extension position based on the initial point, the extension position contained in the extension information, and the predetermined radius;

The local pattern generation unit is used for executing filling processing on the target area according to the predetermined width, and generating the local pattern of the effect object.

On the basis of each of the above-mentioned optional technical solutions, the effect image determination submodule comprises: a pattern cutting unit and an effect image determination unit.

The pattern cutting unit is used for cutting the local pattern based on a predetermined cutting shape to obtain a pattern to be concatenated;

The effect image determination unit is used for obtaining an effect image of the effect object by concatenating the pattern to be concatenated.

On the basis of the above-mentioned optional technical solutions, optionally, the predetermined cutting shape comprises a polygon, and the pattern cutting unit comprises: a pattern cutting subunit and an image stretching subunit.

The pattern cutting subunit is used for cutting the local pattern according to the polygon to obtain the pattern to be concatenated;

The image stretching subunit is used for stretching the pattern to be concatenated and updating the pattern to be concatenated when the polygon is a non-regular polygon.

On the basis of each of the above-mentioned optional technical solutions, the optional effect image determination unit is specifically used for taking the initial point of the patterns to be concatenated as the rotation center and executing rotation processing on the patterns to be concatenated to obtain the effect image of the effect object.

On the basis of the above alternatives, optionally, the effect image comprises the snowflake pattern, the claw pattern, and the branch pattern.

In the technical solution of the embodiments of the present disclosure, the reference trunk direction of the effect object is by determined according to the predetermined initial point and the target offset in response to the image generation condition being satisfied, and at least one piece of extension information is determined according to the initial point, the reference trunk direction and a predetermined target parameter, and finally the effect image of the effect object is generated based on the at least one piece of extension information, solving the problems of a certain limitation of a pattern style of the generated effect image of the effect object and a relatively single display effect of the effect image in the related art, achieving the effect of generating effect images of effect objects randomly, and improving the display effect of effect images on the basis of ensuring the efficiency of generating effect images.

The image generation apparatus provided by an embodiment of the present disclosure can execute the image generation method provided by any embodiment of the present disclosure, and has functional modules and advantageous effects corresponding to the execution method.

It should be noted that the various units and modules comprised in the above-mentioned device are merely divided according to functional logic, but are not limited to the above-mentioned division as long as corresponding functions can be realized; in addition, the specific names of the functional units are also for the convenience of distinguishing each other and are not intended to limit the scope of the disclosed embodiments.

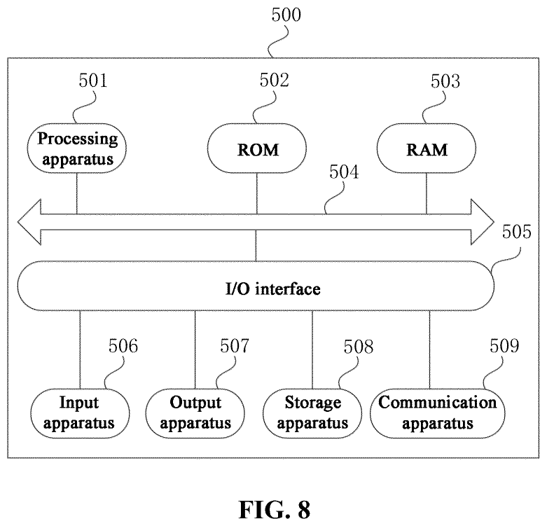

FIG. 8 illustrates a block diagram of an electronic device in accordance with an embodiment of the present disclosure. Reference is now made to FIG. 8, which illustrates a block schematic diagram of an electronic device (e.g. a terminal device or server in FIG. 8) 500 suitable for implementing an embodiment of the present disclosure. The terminal device in the embodiment of the present disclosure may include, but is not limited to, a mobile terminal such as a mobile phone, a notebook computer, a digital broadcast receiver, a PDA (Personal Digital Assistant), a PAD (Tablet Computer), a PMP (Portable Multimedia Player), an in-vehicle terminal (e.g. an in-vehicle navigation terminal), etc. and a fixed terminal such as a digital TV, a desktop computer, etc. The electronic device shown in FIG. 8 is merely an example and should not impose any limitations on the functionality and scope of use of embodiments of the present disclosure.

As shown in FIG. 8, the electronic device 500 may include a processing apparatus (e.g. central processing unit, graphics processor, etc.) 501 that may perform various suitable actions and processes in accordance with a program stored in a read only memory (ROM) 502 or a program loaded from a storage apparatus 508 into a random access memory (RAM) 503. In the RAM 503, various programs and data required for the operation of the electronic device 500 are also stored. The processing apparatus 501, the ROM 502 and the RAM 503 are connected to each other via a bus 504. An edit/output (I/O) interface 505 is also coupled to bus 504.

In general, the following devices may be connected to the I/O interface 505: input apparatus 506 including, for example, touch screens, touch pads, keyboards, mice, cameras, microphones, accelerometers, gyroscopes, etc.; an output apparatus 507 including, for example, a liquid crystal display (LCD), a speaker, a vibrator, etc.; A storage apparatus 508 including, for example, a magnetic tape, a hard disk, etc.; and communication apparatus 509. The communication apparatus 509 may allow the electronic device 500 to communicate wirelessly or wired with other devices to exchange data. While FIG. 8 illustrates an electronic device 500 having various means, it is to be understood that not all illustrated means are required to be implemented or provided. More or fewer devices may alternatively be implemented or provided.

In particular, the processes described above with reference to flow diagrams may be implemented as computer software programs in accordance with embodiments of the present disclosure. For example, embodiments of the present disclosure include a computer program product comprising a computer program embodied on a non-transitory computer-readable medium, the computer program comprising program code for executing the method illustrated by the flowchart. In such embodiments, the computer program may be downloaded and installed from a network via communication apparatus 509, or from storage apparatus 508, or from ROM 502. When the computer program is executed by the processing apparatus 501, the above-described functions defined in the method of the embodiment of the present disclosure are executed.

The names of messages or information interacted between devices in embodiments of the present disclosure are for illustrative purposes only and are not intended to limit the scope of such messages or information.

The electronic device provided by the embodiments of the present disclosure belongs to the same inventive concept as the image generation method provided by the above-mentioned embodiments, and technical details not described in detail in the present embodiments can be referred to the above-mentioned embodiments, and the present embodiments have the same advantageous effects as the above-mentioned embodiments.

Embodiments of the present disclosure provide a computer storage medium having stored thereon a computer program that, when executed by a processor, implements the image generation method provided by the above embodiments.

Note that the computer-readable medium described above in the present disclosure can be either a computer-readable signal medium or a computer-readable storage medium, or any combination of the two. The computer-readable storage medium can be, for example but not limited to, an electronic, magnetic, optical, electromagnetic, infrared, or semiconductor system, apparatus, or device, or a combination of any of the above. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage apparatus, a magnetic storage apparatus, or any suitable combination of the above. In the present disclosure, a computer-readable storage medium can be any tangible medium that contains or stores a program that can be used by or in connection with an instruction execution system, apparatus, or device. In the present disclosure, a computer-readable signal medium may comprise a data signal embodied in baseband or propagated as part of a carrier wave carrying computer-readable program code. Such propagated data signals may take many forms, including but not limited to, electromagnetic signals, optical signals, or any suitable combination of the preceding. The computer-readable signal medium can also be any computer-readable medium other than a computer-readable storage medium that can send, propagate, or transport the program for use by or in connection with the instruction execution system, apparatus, or device. The program code embodied on the computer-readable medium may be transmitted over any suitable medium including, but not limited to: wire, fiber optic cable, RF (radio frequency), and the like, or any suitable combination of the foregoing.

In some embodiments, clients, servers may communicate using any currently known or future developed network protocol, such as HTTP (Hyper Text Transfer Protocol), and may be interconnected with any form or medium of digital data communication (e.g. a communication network). Examples of communication networks include local area networks (“LANs”), wide area networks (“WANs”), internetworks (e.g. the Internet), and peer-to-peer networks (e.g. ad hoc peer-to-peer networks), as well as any currently known or future developed networks.

The computer readable medium may be contained in the electronic device; it may also be present separately and not fitted into the electronic device.

The computer-readable medium carries one or more programs that, when executed by the electronic device, cause the electronic device to: in response to an image generation condition being satisfied, determining a reference trunk direction of an effect object according to a predetermined initial point and a target offset; determining at least one piece of extension information according to the initial point, the reference trunk direction and a predetermined target parameter, wherein the extension information comprises an extension position and a corresponding target extension direction; generating an effect image of the effect object based on the at least one piece of extension information.

Computer program code for carrying out operations of the present disclosure may be written in one or more programming languages, including, but not limited to, object oriented programming languages, such as Java, Smalltalk, C++, and conventional procedural programming languages, such as the “C” language or similar programming languages, or a combination thereof. The program code may execute entirely on the user's computer, partly on the user's computer, as a stand-alone software package, partly on the user's computer partly on a remote computer or entirely on the remote computer or server. In the case of a remote computer, the remote computer may be connected to the user's computer through any kind of network, including a local area network (LAN) or a wide area network (WAN), or it may be connected to an external computer (e.g. through the Internet using an Internet Service Provider).

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems which perform the specified functions or operations, or combinations of special purpose hardware and computer instructions.

The elements described in connection with the embodiments disclosed herein may be implemented in software or hardware. Where the name of the unit does not in some cases constitute a limitation on the unit itself, for example, the first acquisition unit may also be described as “a unit acquiring at least two internet protocol addresses”.

The functions described herein above may be executed, at least in part, by one or more hardware logic components. For example, without limitation, exemplary types of hardware logic components that may be used include: field Programmable Gate Arrays (FPGAs), application Specific Integrated Circuits (ASICs), application Specific Standard Products (ASSPs), systems on a Chip (SOCs), complex Programmable Logic Devices (CPLDs), and the like.

In the context of the present disclosure, a machine-readable medium can be a tangible medium that can contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of a machine-readable storage medium would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage apparatus, a magnetic storage apparatus, or any suitable combination of the preceding.

The foregoing description is only a preferred embodiment of the disclosure and is illustrative of the principles of the technology employed. It will be appreciated by those skilled in the art that the scope of the present disclosure is not limited to any particular combination of the features described above, but is intended to encompass any combination of the features described above or their equivalents without departing from the spirit of the disclosure. For example, the above-mentioned features and the technical features disclosed in the present disclosure (but not limited to) having similar functions are interchanged to form a technical solution.

Further, while operations are depicted in a particular order, this should not be understood as requiring that the operations be executed in the particular order shown or in sequential order. In certain circumstances, multitasking and parallel processing may be advantageous. As such, while several specific implementation details have been included in the above discussion, these should not be construed as limiting the scope of the present disclosure. Certain features that are described in the context of separate embodiments may also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. On the contrast, the specific features and acts described above are merely exemplary forms of implementing the claims.

1. An image generation method, comprising:
determining a reference trunk direction of an effect object according to a predetermined initial point and a target offset in response to an image generation condition being satisfied;
determining at least one piece of extension information according to the initial point, the reference trunk direction and a predetermined target parameter, wherein the extension information comprises an extension position and a corresponding target extension direction; and
generating an effect image of the effect object based on the at least one piece of extension information.

2. The method of claim 1, further comprising:
determining a target parameter for generating the effect image; and
determining the target parameter for generating the effect image comprises:
determining the target parameter according to a predetermined interval between adjacent video frames, position information of at least one element in an initialization parameter, and a target function.

3. The method of claim 2, wherein the target parameter comprises at least one pseudo-random number.

4. The method of claim 1, wherein the image generation condition comprises at least one of:
triggering a control for generating the effect image corresponding to the 1 effect object;
a multimedia data stream comprising predetermined picture content and/or a predetermined audio clip; and
a current environmental parameter matching a predetermined environmental parameter for adding the effect image.

5. The method of claim 1, wherein determining the at least one piece of extension information according to the initial point, the reference trunk direction and the predetermined target parameter comprises:
determining an initial position of the initial point within the target parameter;
determining, among the target parameter, a parameter to be selected of at least one vicinity position adjacent to the initial position;
determining at least one target number according to the parameter to be selected and a predetermined parameter threshold; and
determining a target extension direction and an extension position contained in the extension information based on a vicinity position corresponding to the at least one target number, the reference trunk direction and the initial point.

6. The method of claim 5, wherein the target number comprises one target number, the extension information comprises trunk extension information, and determining the target extension direction and the extension position contained in the extension information based on the vicinity position corresponding to the at least one target number, the reference trunk direction and the initial point comprises:
taking the vicinity position of the target number in the target parameter as the extension position in the trunk extension information; and
determining a target trunk extension direction and a target trunk extension length of the effect object according to the extension position and the initial point.

7. The method of claim 5, wherein the target number comprising a plurality of target numbers, the extension information comprising trunk extension information and branch extension information, and determining the target extension direction and the extension position contained in the extension information based on the vicinity position corresponding to the at least one target number, the reference trunk direction and the initial point comprises:
determining relative deflection angles between connecting lines between the initial point and vicinity positions corresponding to a plurality of the target numbers and the reference trunk direction;
taking a vicinity position corresponding to a minimum relative deflection angle as a trunk extension position in the trunk extension information, and determining a target trunk extension direction in the trunk extension information according to the trunk extension position and the initial point; and
taking vicinity positions corresponding to other target numbers as branch extension positions in the branch extension information, and determining target branch extension directions in the branch extension information according to the branch extension positions and the initial point.

8. The method of claim 4, wherein the method further comprises, after determining the extension position:
taking a point corresponding to the extension position as the initial point, and repeatedly executing a step of determining the at least one piece of extension information according to the initial point, the reference trunk direction and the predetermined target parameter.

9. The method of claim 8, further comprising:
stopping executing a step of determining trunk extension information in the extension information when an extension position in the trunk extension information in the at least one piece of extension information reaches a predetermined extension boundary; and
stopping executing a step of determining branch extension information in the extension information when a number of times of execution of extension information belonging to a same branch in the at least one piece of extension information reaches a predetermined number threshold.

10. The method of claim 1, wherein generating the effect image of the effect object based on the at least one piece of extension information comprises:
drawing a local pattern of the effect object based on the at least one piece of extension information; and
determining the effect image of the effect object based on the local pattern.

11. The method of claim 10, wherein drawing the local pattern of the effect object based on the at least one piece of extension information comprises:
determining a target area surrounding the initial point and an extension position contained in the extension information based on the initial point, the extension position and a predetermined radius; and
filling the target area according to a predetermined width to generate the local pattern of the effect object.

12. The method of claim 10, wherein determining the effect image of the effect object based on the local pattern comprises:
cutting the local pattern according to a polygon to obtain a pattern to be concatenated;
stretching and updating the pattern to be concatenated when the polygon is a non-regular polygon; and
obtaining the effect image of the effect object by concatenating the pattern to be concatenated.

13. An electronic device, comprising:
one or more processors; and
a storage apparatus for storing one or more programs,
the one or more programs, when executed by the one or more processors, cause the one or more processors to implement an image generation method comprising:
determining a reference trunk direction of an effect object according to a predetermined initial point and a target offset in response to an image generation condition being satisfied;
determining at least one piece of extension information according to the initial point, the reference trunk direction and a predetermined target parameter, wherein the extension information comprises an extension position and a corresponding target extension direction; and
generating an effect image of the effect object based on the at least one piece of extension information.

14. The electronic device of claim 13, wherein the method further comprises:
determining a target parameter for generating the effect image; and
determining the target parameter for generating the effect image comprises:
determining the target parameter according to a predetermined interval between adjacent video frames, position information of at least one element in an initialization parameter, and a target function.

15. The electronic device of claim 14, wherein the target parameter comprises at least one pseudo-random number.

16. The electronic device of claim 13, wherein the image generation condition comprises at least one of:
triggering a control for generating the effect image corresponding to the effect object;
a multimedia data stream comprising predetermined picture content and/or a predetermined audio clip; and
a current environmental parameter matching a predetermined environmental parameter for adding the effect image.

17. The electronic device of claim 13, wherein determining the at least one piece of extension information according to the initial point, the reference trunk direction and the predetermined target parameter comprises:
determining an initial position of the initial point within the target parameter;
determining, among the target parameter, a parameter to be selected of at least one vicinity position adjacent to the initial position;
determining at least one target number according to the parameter to be selected and a predetermined parameter threshold; and
determining a target extension direction and an extension position contained in the extension information based on a vicinity position corresponding to the at least one target number, the reference trunk direction and the initial point.

18. The electronic device of claim 17, wherein the target number comprises one target number, the extension information comprises trunk extension information, and determining the target extension direction and the extension position contained in the extension information based on the vicinity position corresponding to the at least one target number, the reference trunk direction and the initial point comprises:
taking the vicinity position of the target number in the target parameter as the extension position in the trunk extension information; and
determining a target trunk extension direction and a target trunk extension length of the effect object according to the extension position and the initial point.

19. The electronic device of claim 17, wherein the target number comprising a plurality of target numbers, the extension information comprising trunk extension information and branch extension information, and determining the target extension direction and the extension position contained in the extension information based on the vicinity position corresponding to the at least one target number, the reference trunk direction and the initial point comprises:
determining relative deflection angles between connecting lines between the initial point and vicinity positions corresponding to a plurality of the target numbers and the reference trunk direction;
taking a vicinity position corresponding to a minimum relative deflection angle as a trunk extension position in the trunk extension information, and determining a target trunk extension direction in the trunk extension information according to the trunk extension position and the initial point; and
taking vicinity positions corresponding to other target numbers as branch extension positions in the branch extension information, and determining target branch extension directions in the branch extension information according to the branch extension positions and the initial point.

20. A non-transitory storage medium containing computer-executable instructions, wherein the computer-executable instructions, when executed by a computer processor, perform an image generation method comprising:
determining a reference trunk direction of an effect object according to a predetermined initial point and a target offset in response to an image generation condition being satisfied;
determining at least one piece of extension information according to the initial point, the reference trunk direction and a predetermined target parameter, wherein the extension information comprises an extension position and a corresponding target extension direction; and
generating an effect image of the effect object based on the at least one piece of extension information.
